(19) United States
(12) Patent Application Publication
(10) Pub. No.: US 2013/0119792 A1
(43) Pub. Date: May 16, 2013

(54) ELECTRICAL POWER TOOLS

(71) Applicant: MAKITA CORPORATION, Anjo-shi (JP)

(72) Inventors: Takeshi NISHIMIYA, Anjo-shi (JP); Yutaka MATSUNAGA, Anjo-shi (JP)

(73) Assignee: MAKITA CORPORATION, Anjo-shi (JP)

(21) Appl. No.: 13/741,004

(22) Filed: Jan. 14, 2013

Related U.S. Application Data
(62) Division of application No. 12/379,796, filed on Mar. 2, 2009.

(30) Foreign Application Priority Data
Mar. 12, 2008 (JP) 2008-062468

(51) Int. Cl. H02K 7/14; H02K 11/00

(52) U.S. Cl. CPC H02K 7/145; H02K 11/0073
USPC 310/50

(57) ABSTRACT

An electrical power tool may include a switching device capable of controlling output power of a motor, a circuit board supporting the switching device, and a metal case receiving the circuit board. The switching device includes a conductive part and an insulated portion that is covered by an insulating covering material. The conductive part of the switching device contacts the circuit board. The insulated portion of the switching device contacts the metal case via the insulating covering material.

This application is a U.S. Divisional of U.S. application Ser. No. 12/379,796 filed Mar. 2, 2009, which claims the benefit of priority to Japanese Patent Application No. 2008-062468 filed Mar. 12, 2008, the contents of which are incorporated herein by reference.

### BACKGROUND OF THE INVENTION

1. Field of the Invention

The present invention relates to electrical power tools. More particularly, the present invention relates to electrical power tools in which output power of a motor can be controlled by switching devices.

2. Description of Related Art

For example, a router (an electrical power tool) having a switching device is already known. As shown in FIG. 6(A), in the router, a triac (bidirectional thyristor) 101 is used as the switching device. The triac 101 can control currents supplied to a motor, thereby controlling output power of the motor. The triac 101 is composed of a semiconductor chip 102 that is disposed in an aluminum case 105. The chip 102 is positioned such that a surface thereof or MT2 terminal (FIG. 6(B)) contacts a bottom surface of the case 105. Conversely, remaining surfaces of the chip 102 are covered by a covering member 103. Further, the triac 101 has an MT1 terminal and a gate (G) terminal. These terminals are connected to conductive parts of a circuit board 104 via lead wires 104. In the switching device, the case 105 may function as a part of the MT2 terminal of the triac 101. Therefore, heat produced from the tip 102 can be directly transmitted to the aluminum case 105. As a result, the triac may have increased heat dissipation characteristics.

Further, the aluminum case 105 is filled with a synthetic resin 106 in order to isolate side surfaces of the case 105 from the triac 101 and the circuit board 104.

In the electrical power tool described above, the MT2 terminal (i.e., a conductive part) of the triac 101 contacts the aluminum case 105. Therefore, if a plurality of switching devices (e.g., PETS) are disposed in the case 105, conductive parts of the switching devices can electrically short-circuited. This means that a plurality of switching devices cannot be disposed in the case 105.

Such an electrical power tool is taught, for example, by Japanese Laid-Open Patent Publication Number 11-77608.

### BRIEF SUMMARY OF THE INVENTION

In one aspect of the present invention, an electrical power tool may include a switching device capable of controlling output power of a motor, a circuit board supporting the switching device, and a metal case receiving the circuit board. The switching device includes a conductive part and an insulated portion that is covered by an insulating covering material. The conductive part of the switching device contacts the circuit board. The insulated portion of the switching device contacts the metal case via the insulating covering material.

According to this aspect, heat produced from the switching device can be effectively dissipated via conductive parts of the circuit board and the metal case. This may lead to increased heat dissipation characteristics of the switching device.

Further, the conductive part of the switching device can be electrically insulated from the metal case. Therefore, if a plurality of switching devices are attached to the circuit board, conductive parts of the switching devices can be effectively prevented from being electrically short-circuited.

Optionally, the metal case is filled with an insulating filling material, so that the circuit board can be embedded therein.

Other objects, features and advantages of the present invention will be readily understood after reading the following detailed description together with the accompanying drawings and the claims.

### BRIEF DESCRIPTION OF THE DRAWINGS

FIG. 1 is a side view of an electrical power tool according to a representative embodiment of the present invention;

FIG. 2 is a circuit diagram of a DC brushless motor;

FIG. 3 is a sectional view of a case having a circuit board;

FIG. 4 is a bottom plane view of the circuit board;

FIG. 5 is a top plane view of the circuit board;

FIG. 6(A) is a sectional view of a case having a circuit board in a conventional electrical power tool; and

FIG. 6(B) is a diagrammatic sectional view of a triac used in the conventional electrical power tool.

### DETAILED DESCRIPTION OF THE INVENTION

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

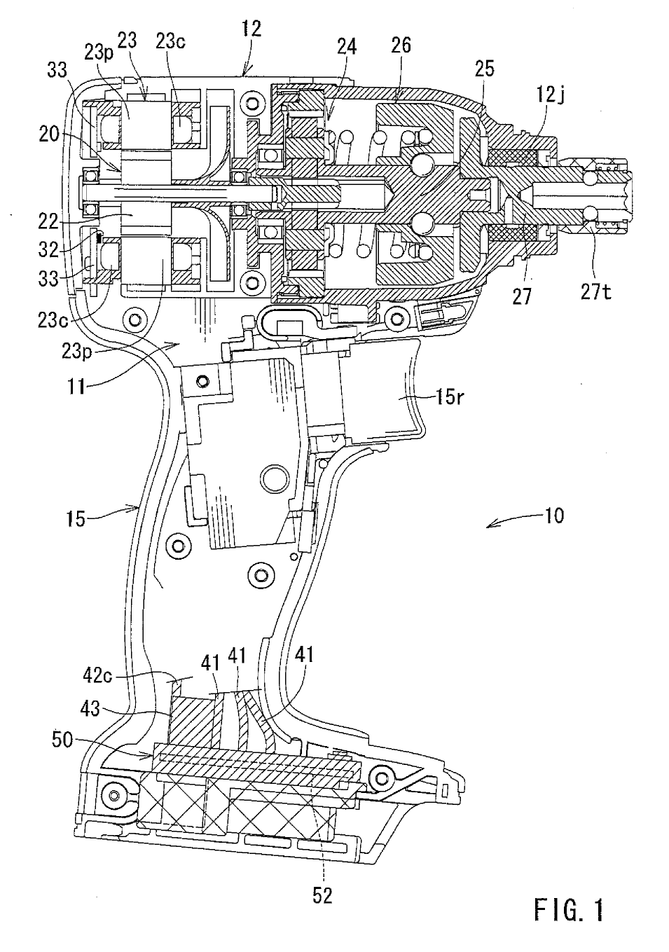

A detailed representative embodiment of the present invention will be described with reference FIGS. 1 to 5. In the embodiment, an electrical impact driver 10 (which will be simply referred to as an impact driver 10) powered by a DC brushless motor 20 is exemplified as an electrical power tool.

As shown in FIG. 1, the impact driver 10 includes a housing 11 that is composed of a hollow main body portion 12 and a grip portion 15 that is extended downwardly from the main body portion 12. The grip portion 15 is provided with a trigger-type switch lever 15r. The switch lever 15r may preferably be positioned such that a user can easily manipulate the switch lever 15r with his/her fingers while gripping the grip portion.

Disposed in the main body portion 12 of the housing 11 are the DC brushless motor 20, a planetary gear mechanism 24, a spindle 25, an impact force generation mechanism 26 and an anvil 27. As shown in FIG. 1, these components are transversely concentrically arranged in this order from the back of the main body portion 12. The DC brushless motor 20 may function as a drive source of the impact driver 10. A rotational speed of the DC brushless motor 20 is reduced by the planetary gear mechanism 24 and is then transmitted to the spindle 25. Upon rotation of the spindle 25, a rotational force is produced. The rotational force produced by the spindle 25 is transmitted to the impact force generation mechanism 26 and is transferred to a rotational impact force by the impact force generation mechanism 26. The rotational impact force is transmitted to the anvil 27. The anvil 27 is rotatably and axially immovably supported via a bearing 12j that is positioned at a forward end of the main body portion 12 of the housing 11. Thus, the anvil 27 can be rotated about an axis by the rotational impact force. Further, a chuck 27t is attached to a distal end of the anvil 27 in order to attach a driver bit, a socket bit or other such bits (not shown) to the anvil 27.

As shown in FIG. 1, the DC brushless motor 20 is composed of a rotor 22 having permanent magnets and a stator 23 having drive coils 23c. The stator 23 may preferably include a cylindrical outer shell portion (not shown) and six tooth members 23p that are radially inwardly projected from the shell portion. The drive coils 23c are respectively attached to the tooth members 23p. The tooth members 23p are positioned circumferentially so as to be equally spaced. Conversely, the rotor 22 is concentrically disposed within the stator 23. Therefore, the tooth members 23p (the drive coils 23c) of the stator 23 are positioned around the rotor 22.

Further, disposed on a rear side of the stator 23 is a magnetic sensor 32 that is capable of detecting rotational positions of magnetic poles of the rotor 22. The magnetic sensor 32 may preferably be attached to the stator 23 via a sensor attachment board 33. Also, the magnetic sensor 32 is electrically connected to a control unit 46 contained in an electrical circuit 40 (which will be described hereinafter). Therefore, the control unit 46 is capable of applying electrical current to the drive coils 23c of the stator 23 in series based upon signals representative of the rotational positions of the magnetic poles of the rotor 22, thereby controllably rotating the rotor 22.

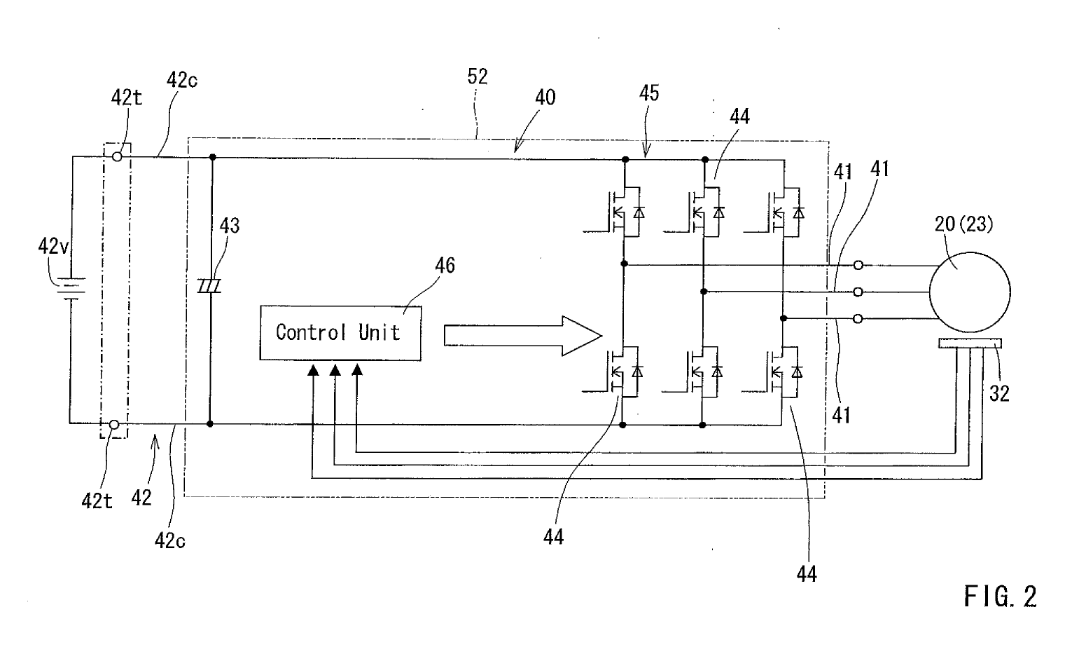

As shown in FIG. 2, the electrical circuit 40 functions to apply electrical current (power) to the DC brushless motor 20. The electrical circuit 40 includes an electrical current source 42 and a three-phase bridge circuit 45 that is composed of six switching devices 44. Further, examples of the switching devices 44 are field-effect transistors (PETS). Also, as previously described, the electrical circuit 40 includes the control unit 46 that is capable of controlling the switching devices 44 of the three-phase bridge circuit 45. The electrical current source 42 may preferably include a battery 42v, electrical cables 42c and a smoothing capacitor 43. The battery 42v is connected to the electrical cables 42c via terminals 42t. The smoothing capacitor 43 is connected to the electrical cables 42c in parallel with the battery 42v.

The three-phase bridge circuit 45 is connected to the electrical cables 42c in parallel with the smoothing capacitor 43. The three-phase bridge circuit 45 has three output cables 41 (which will be referred to as power cables 41). The power cables 41 are respectively connected to the drive coils 23c of the stator 23 of the DC brushless motor 20.

The control unit 46 is electrically communicated with the switching devices 44 of the three-phase bridge circuit 45. Also, as previously described, the control unit 46 is electrically connected to the magnetic sensor 32. Therefore, the control unit 46 is capable of generating on-off signals based upon the signals from the magnetic sensor 32 and transmitting the on-off signals to the switching devices 44 of the three-phase bridge circuit 45, as shown by an outline arrow in FIG. 2. Thus, the electrical current is applied to the drive coils 23c of the stator 23 in series, so that the rotor 22 can be controllably rotated.

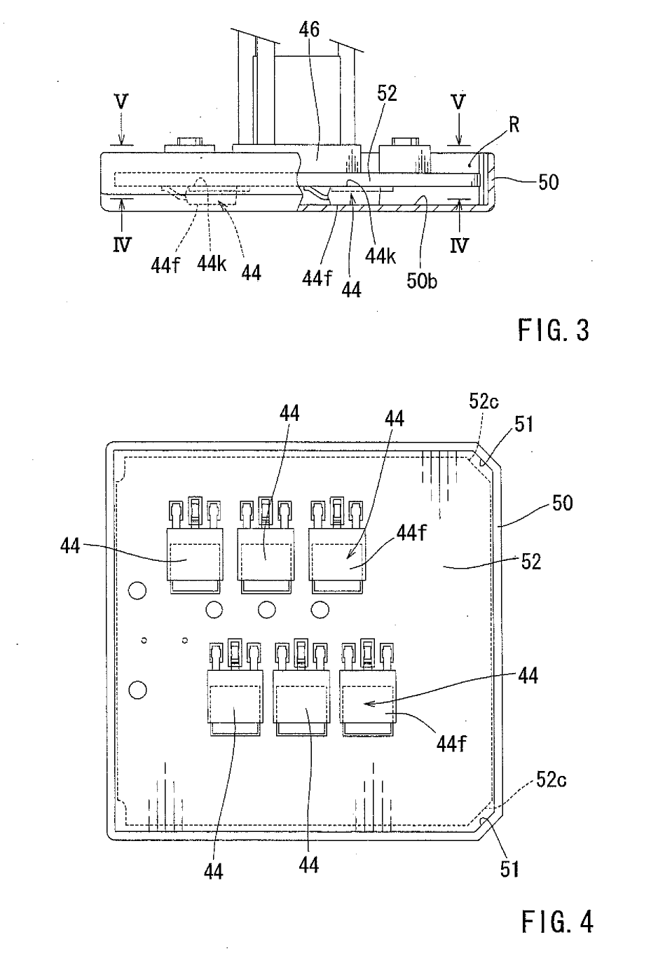

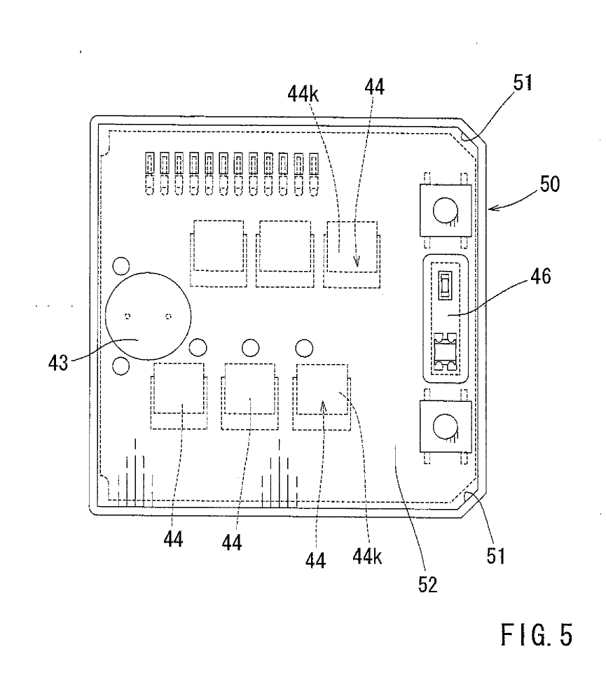

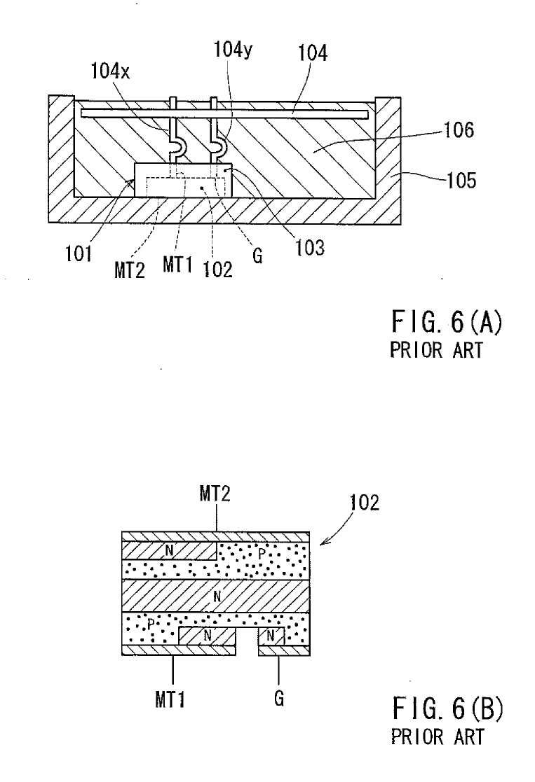

Further, the electrical circuit 40 is formed in a circuit board 52 that is disposed in a case 50 made of aluminum alloy (FIGS. 3-5). In particular, the case 50 is a rectangular open-topped box-shaped (rectangular dish-shaped) container. Conversely, the circuit board 52 has the substantially same shape as the case 50 and is shaped so as to be received in the case 50. As best shown in FIG. 4, the switching devices 44 of the three-phase bridge circuit 45 are attached to a lower side of the circuit board 52. The switching devices 44 are positioned in two rows three by three. Each of the switching devices 44 has a conductive part 44k (a drain terminal) and an insulated portion that is covered by an insulating synthetic resin layer 44f (an insulating covering material). The switching devices 44 are positioned on the rear side of the circuit board 52 such that the conductive part 44k contacts the circuit board 52. Conversely, as best shown in FIG. 5, the smoothing capacitor 43 and the control unit 46 are attached to an upper side of the circuit board 52.

As shown in FIG. 3, the circuit board 52 having the electrical circuit 40 is incorporated into the case 50 such that the switching devices 44 are positioned on a bottom surface 50b of the case 50. Further, the circuit board 52 may preferably positioned so as to be in parallel with the bottom surface 50b of the case 50. At this time, the synthetic resin layers 44f of the switching devices 44 contact the bottom surface 50b of the case 50. In other wards, the switching devices 44 do not electrically contact the bottom surface 50b of the case 50.

Further, as shown in FIGS. 3 and 4, the case 50 may preferably have chamfered portions 51 that are formed in adjacent two corner portions thereof. Conversely, the circuit board 52 may preferably have chamfered portion 52c that are formed in adjacent two corner portions thereof. Therefore, the circuit board 52 can be easily incorporated into the case 50 while the circuit board 52 is correctly oriented.

Further, the case 50 having the circuit board 52 is filled with a thermoplastic insulating resin R (a filling material), so that the circuit board 52 can be embedded therein. Thus, the circuit board 52 can be integrated with the case 50 via the resin R.

As shown in FIG. 1, the case 50 having the circuit board 52 may preferably be disposed on a lower portion of the grip portion 15 of the housing 11.

Thus, in the impact driver 10 of the present embodiment, the conductive parts 44k of the switching devices 44 contact the circuit board 52. Conversely, the insulated portions of the switching devices 44 contact the bottom surface 50b of the case 50 via the synthetic resin layers 44f. Therefore, heat produced from the switching devices 44 can be effectively dissipated via conductive parts of the circuit board 52 and the case 50. This may lead to increased heat dissipation characteristics of the switching devices 44.

Further, the switching devices 44 are electrically insulated from the case 50 via resin layers 44f. That is, the conductive parts 44k of the switching devices 44 are electrically insulated from the case 50. Therefore, the conductive parts 44k of the switching devices 44 can be effectively prevented from being electrically short-circuited. This means that a plurality of switching devices 44 can be disposed in the case 50.

Also, the switching devices 44 can be attached to an entire area of the circuit board 52. Therefore, a large number of switching devices 44 can be attached to the circuit board 52. In addition, the circuit board 52 is combined with the case 50 while the switching devices 44 are interleaved therebetween. As a result, the circuit board 52 can be positioned closer to the case 50. Therefore, thickness of the case 50 can be reduced.

Various changes and modifications may be made to the present invention without departing from the scope of the previously shown and described embodiment. For example, in the embodiment, the case 50 is made of aluminum alloy. However, the case 50 can be made of copper, steel, stainless steel or other such metals.

Further, FETS are exemplified as the switching devices 44. However, the switching devices 44 may be semiconductor devices or other such devices.

Further, in the embodiment, the electrical impact driver 10 is exemplified as the electrical power tool. However, an electrical drill, an electrical disk saw and other such machines can be used as the electrical power tool.

What is claimed is:

1. An electrical power tool, comprising:
a motor housing;
a motor received in the motor housing;
a grip housing connected to the motor housing;
a switch lever attached to one side of the grip housing;
a battery to feed electrical power to the motor;
a circuit board disposed in the other side of the grip housing;
a switching device attached to the circuit board; and
a heat dissipating portion configured to dissipate heat generated by the switching device.

2. The electrical power tool as defined in claim 1, wherein the circuit board is positioned on an enlarged portion formed in a lower portion of the grip housing.

3. The electrical power tool as defined in claim 1, wherein the switching device is positioned on one surface of the circuit board which surface faces one side of the grip housing, and wherein the heat dissipating member is positioned on one surface of the circuit board.

4. The electrical power tool as defined in claim 1 further comprising an insulating material covering the circuit board.

5. The electrical power tool as defined in claim 1 further comprising a control unit attached to the circuit board.

6. The electrical power tool as defined in claim 1 further comprising a capacitor attached to the circuit board.

7. An electrical power tool, comprising:
a motor housing extended in a front-rear direction;
a motor received in a rear portion of the motor housing;
a grip housing connected to a lower portion of the motor housing and extended vertically;
a switch lever attached to an upper front portion of the grip housing;
a planetary gear mechanism positioned before the motor;
a chuck positioned before the planetary gear mechanism;
a battery to feed electrical power to the motor;
a circuit board disposed positioned on a lower portion of the grip housing and extended in the front-rear direction;
a plurality of switching elements attached to one surface of the circuit board; and
a heat dissipating portion disposed in the lower portion of the grip housing and configured to dissipate heat generated by the switching elements.

8. An electrical power tool, comprising:
a motor housing;
a brushless motor received in the motor housing;
a first board secured to the brushless motor;
a grip housing connected to the motor housing;
a switch lever attached to the grip housing;
a battery to feed electrical power to the brushless motor;
a second board disposed in the grip housing and positioned across the switch lever from the brushless motor;
a plurality of switching elements attached to the second board; and
a heat dissipating portion configured to dissipate heat generated by the switching elements.
